(19) United States
(12) Patent Application Publication
(10) Pub. No.: US 2011/0202709 A1
(43) Pub. Date: Aug. 18, 2011

(54) OPTIMIZING STORAGE OF COMMON PATTERNS IN FLASH MEMORY

(75) Inventor: Bohuslav Rychlik, San Diego, CA (US)

(73) Assignee: RAMBUS INC., Los Altos, CA (US)

(21) Appl. No.: 12/922,543

(22) PCT Filed: Mar. 4, 2009
(86) PCT No.: PCT/US09/36021

§ 371 Date: Oct. 25, 2010

Related U.S. Application Data
(62) Division of application No. 61/037,985, filed on Mar. 19, 2008.

(51) Int. Cl. G06F 12/02; G06F 12/00

(52) U.S. Cl. 711/103; 711/154; 711/E12.001; 711/E12.008

(57) ABSTRACT

One embodiment of the present invention provides a method of operation within a flash memory system. During operation, the system receives write data and a corresponding logical address. The system then determines whether the write data matches a predetermined data pattern. If the write data does match the predetermined data pattern, instead of writing the data, the system records an indication that the predetermined data pattern corresponds to the logical address.

### BACKGROUND

This disclosure generally relates to flash memory systems. In particular, this disclosure relates to optimizing storage of common data patterns in a flash memory system.

Flash memory has gained tremendous popularity due to its compact size, low power consumption, and increasing capacity. However, unlike other types of random-access memory (RAM), a flash memory has a limited number of erase-write cycles, and hence suffers from penalties associated with erasing, writing, and reading data. Existing flash memory systems typically use logical-to-physical page mapping to skip bad or worn memory pages, and use wear leveling to distribute erasures and re-writes more evenly across the medium. However, these techniques can only extend the lifetime of a flash memory to a limited degree. Additionally, the writing of a flash memory page tends to be a slow operation in general

### BRIEF DESCRIPTION OF THE FIGURES

FIG. 1 illustrates an exemplary computer system that facilitates optimized storage of common data patterns in a flash memory system, in accordance with an embodiment of the present invention.

FIG. 2 illustrates an exemplary flash memory system that maps multiple logical pages of a common data pattern to one physical page, in accordance with an embodiment of the present invention.

FIG. 3 illustrates an exemplary flash memory system that maps multiple logical pages of a common data pattern to one virtual page, in accordance with an embodiment of the present invention.

FIG. 4 illustrates different possible locations for a common-data-pattern detector, in accordance with an embodiment of the present invention.

FIG. 5 illustrates an exemplary implementation of a byte-serial common-value detector, in accordance with an embodiment of the present invention.

FIG. 6 presents a flowchart illustrating the operation of a hierarchical common-data-pattern detector, in accordance with an embodiment of the present invention.

FIG. 7 illustrates an exemplary secondary table that stores common data patterns and is indexed by the digest of the data patterns, in accordance with an embodiment of the present invention.

FIG. 8 illustrates an exemplary flash memory system that facilitates read operations of multiple pages of common data patterns, which are mapped to one virtual page, in accordance with an embodiment of the present invention.

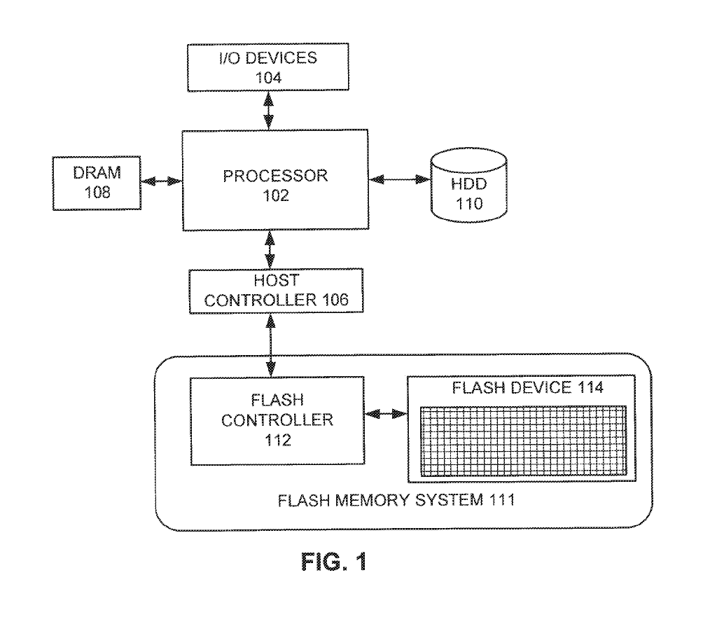

In the drawings, the same reference numbers identify identical or substantially similar elements or acts. The most significant digit or digits in a reference number refer to the figure number in which that element is first introduced. For example, element 100 is first introduced in and discussed in conjunction with FIG. 1.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Embodiments of the present invention provide a flash memory system that facilitates optimized storage of common data patterns. By mapping multiple logical pages of a common data pattern to one physical page or virtual page, the system can reduce the erase-write cycles previously required for writing these pages. Furthermore, because the system obviates the need to access flash memory array, the time required to perform a write or read operation can be considerably reduced.

The present system is particularly useful in a computer system that routinely initializes many pages in the flash memory to a common value such as “0.” In general, repeatedly erasing and programming large numbers of flash pages to all 0s can waste valuable read-write cycles. This zero initialization may occur despite attempts at the operating-system level to reduce these operations. Such initialization may also occur without a programmer's full awareness, because some programming languages such as C automatically zero-initialize data structures. Furthermore, the programmer may write code that re-clears a previously allocated memory region during the normal execution of the program, which is a typical programming practice.

These operations can be very wasteful in terms of erase-write cycles. The present system mitigates such waste by mapping multiple logical pages of a common data pattern to a single physical or virtual page, thereby obviating the need to repeatedly write the same data. This way, the system not only saves the erase-write cycles, but also speeds up the write and read operations by avoiding access to the flash memory array.

In some embodiments, the system provides the option to turn off the optimized storage of common-data-pattern pages, whereby the logical pages are mapped to the physical pages in the conventional way. This function can facilitate low-level testing of the flash memory system.

FIG. 1 illustrates an exemplary computer system that facilitates optimized storage of common data patterns in a flash memory system, in accordance with an embodiment of the present invention. In this example, a processor 102 is coupled to a hard drive 110, a number of I/O devices 104, and a dynamic RAM (DRAM) 108. Processor 102 is also coupled to a host controller 106 which controls the communication with a flash memory system 111, which includes a flash controller 112 and a flash device 114. Flash controller 112 handles the read and write operations between host controller 106 and flash device 114.

Typically, data in a flash device is stored in pages. A page is a group of memory words that are accessed in parallel. During a read or write operation, host controller 106 communicates a logical page number to flash memory system 111, and receives or transmits the corresponding data for that page. Flash controller 112 maintains a map table that maps a logical page to a physical page. This map table allows flash memory system 111 to skip unusable physical pages and implement wear leveling. Generally, a copy of the map table is stored in the flash device, and is loaded into a static RAM (SRAM) within flash controller 112 during initialization.

In one embodiment, during a write operation, flash controller 112 receives a logical page number and a set of data to be written into flash device 114. When flash controller 112 detects that the received data conforms to a common data pattern, flash controller 112 records a corresponding indication without writing the data into flash device 114. In one embodiment, flash controller 112 maps multiple logical pages containing the common data pattern to one physical page. When the common data pattern is some predefined value pattern, such as all “0”s or “1”s, flash controller 112 can also map the logical page to a virtual page that corresponds to this common value. This way, the system can avoid repetitive write operations with the same data pattern.

Note that flash memory system 111 can be any type of internal or external storage device, such as solid-state drive (SSD) and secure digital (SD) card. Furthermore, the computer system illustrated in FIG. 1 can be a desktop computer, laptop computer, personal digital assistant (PDA), mobile phone, multi-media player, digital/video camera, or any computing device.

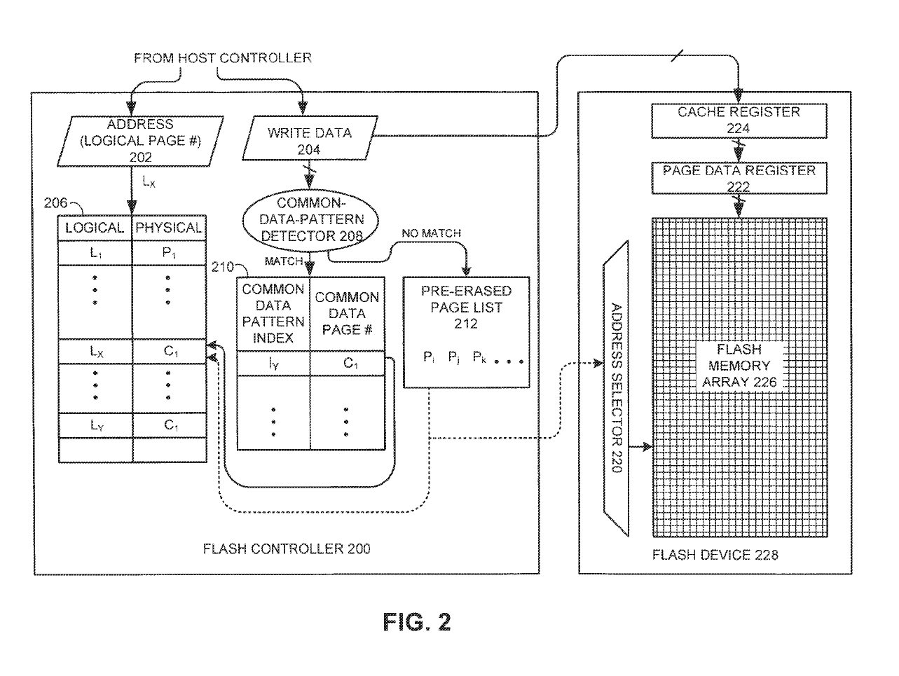

FIG. 2 illustrates an exemplary flash memory system that maps multiple logical pages of a common data pattern to one physical page, in accordance with an embodiment of the present invention. The flash memory system in this example includes a flash controller 200 and a flash device 228. Flash controller 200 includes a map table 206, a common-data-pattern detector 208, a common-data-page table 210, and a pre-erased page list 212. Flash controller 200 receives a logical page number 202 and a set of write data 204 from a host controller during a write operation.

Flash device 228 includes a flash memory array 226 and an address selector 220, and may optionally include a cache register 224 and a page data register 222. Address selector 220 receives a physical page number from flash controller 200 and selects the corresponding page in flash memory array 226. Cache register 224 and page data register 222 form a two-stage pipeline buffer for data access to flash memory array 226.

During a write operation, flash controller 200 receives a logical address 200 denoted as L_{X}. Flash controller 200 also receives and feeds the corresponding write data 204 into common-data-pattern detector 208. Common-data-pattern detector 208 determines that write data 204 matches the content of one of the previously stored pages, and produces a common data page number C₁ by searching common-data-page table 210. In one embodiment, common-data-page table 210 stores the page numbers of common data patterns and is indexed by a common-data-pattern index, which can be a digest (e.g., a hash) of the common data pattern.

In one embodiment, the common data page numbers stored in common-data-page table 210 are physical page numbers for the corresponding data pattern. In the example in FIG. 1, common-data-pattern detector 208 determines that write data 204 corresponds to common-data-pattern index I_{Y}, which in turn is associated with page number C₁. The system then enters C₁ into map table 206, such that logical page number L_{X} is now associated with C₁. Note that another logical page number, L_{Y}, is also associated with C₁, because the write data for L_{Y} also matches the same data pattern. Since this common data pattern is already stored at page number C₁ in flash memory array 226, the system does not need to write the data to flash memory array 226.

If common-data-pattern detector 208 determines that write data 204 does not match any common data pattern, common-data-pattern detector 208 can fetch a pre-erased physical page number from pre-erased page list 212. This page number is then entered into map table 206 (denoted by the dotted lines in FIG. 2). Furthermore, this pre-erased page number is communicated to address selector 220, so that the correct physical page in flash memory array 226 is selected. In addition, common-data-pattern detector 208 also allows write data 204 to be transmitted to flash device 228, so that write data 204 can be written to the selected physical page in flash memory array 226.

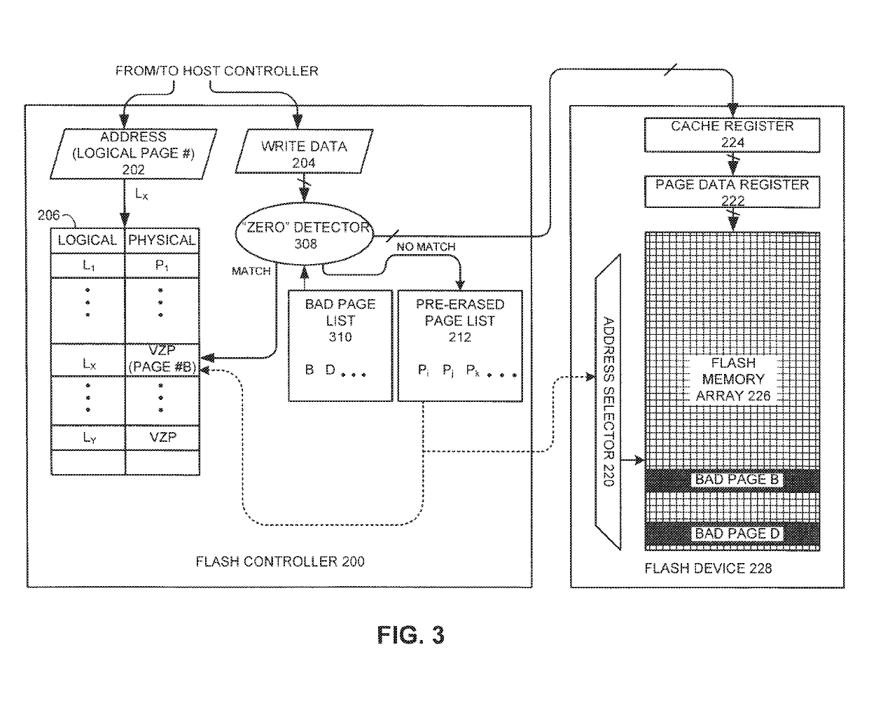

The system can further reduce the number of write operations when write data 204 contains a predetermined common value, such as all “0” or “1.” In one embodiment, instead of mapping a logical page to a physical page, the system can map the logical page to a virtual page corresponding to the common value. FIG. 3 illustrates an exemplary flash memory system that maps multiple logical pages of a common data pattern to one virtual page, in accordance with an embodiment of the present invention. In this example, flash controller 200 feeds write data 204 received from the host controller to a common-value detector, such as “zero” detector 308. Note that the common-value detector can also be a “one” detector or a detector for some other predetermined value, calculated at any desired granularity such as per-bit, per-byte, per-word, etc. When “zero” detector 308 determines that write data 204 for logical page L_{X} contains all “0”s, a virtual page number VZP is entered into map table 206.

The virtual page number can be a special code that indicates the common value. Optionally, the system can also use an existing but unusable physical page number as the virtual page number, since an unusable physical page cannot be used for storing data. For example, as illustrated in FIG. 3, “zero” detector 308 can fetch an unusable page number B from bad page number list 310 and associate it with logical page number L_{X}.

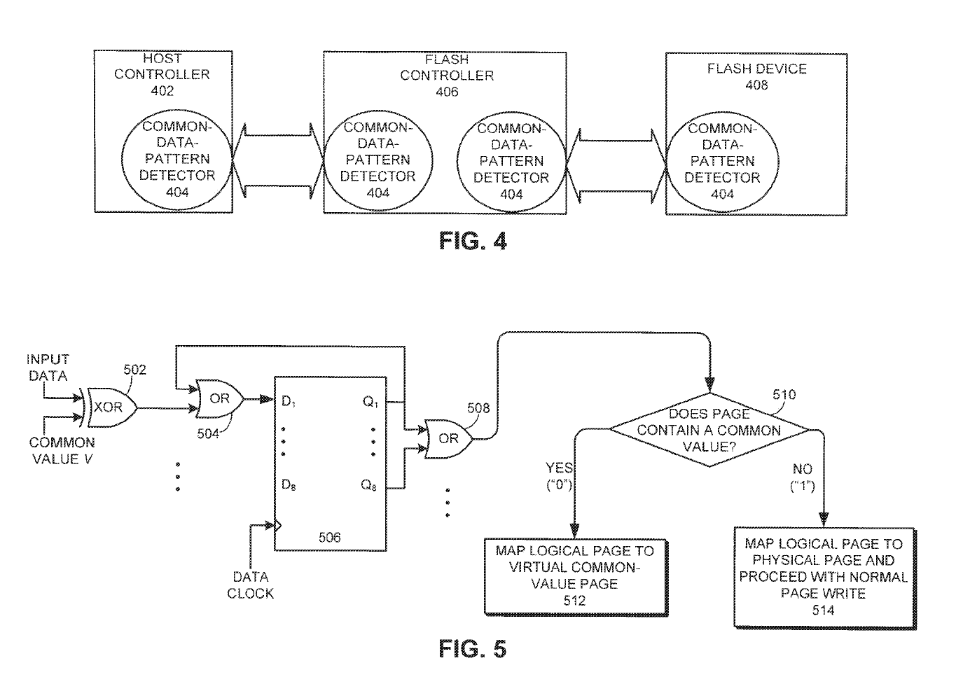

Note that the common-data-pattern detector can reside in different locations, as illustrated in FIG. 4. A common-data-pattern detector 404 can reside within a flash controller 406, close to the data path to a host controller 402, or close to the data path to a flash device 408. Common-data-pattern detector 404 can also reside in flash device 408. In some embodiments, common-data-pattern detector 404 can reside in host controller 402. Note that, since host controller 402 typically does not reside within a flash memory system, host controller 402 may use additional signaling to communicate to flash controller 406 after detecting a common data pattern.

A common-data-pattern detector can use various approaches to detect data values. In one embodiment, the system uses a serial common-value detection mechanism to detect whether an incoming page of data contains the same value. FIG. 5 illustrates an exemplary implementation of a byte-serial common-value detector, in accordance with an embodiment of the present invention. In this exemplary configuration, the data bus is eight bits wide, and the system examines the value of each data bit in parallel, using eight similar circuits. FIG. 5 illustrates the operation of one such circuit.

The incoming bits and a common value ν, which can be “0” or “1,” are first fed into an XOR gate 502. Whenever the incoming bit is different from common value ν, the output of XOR gate 502 becomes 1; otherwise, the output is 0. The output of XOR gate 502 is then fed into an OR gate 504, whose output is fed into a register 506. In one embodiment, register 506 is an eight-bit-wide flip-flop that can simultaneously store eight one-bit values for the eight bit-value-comparison circuits. The inputs of register 506 are denoted as D₁-D₈, and the outputs Q₁-Q₈. The output Q₁, which corresponds to the output of OR gate 504, is fed back to an input of OR gate 504. This feedback configuration of XOR gate 502, OR gate 504, and register 506 ensures that whenever OR gate 504 outputs a “1,” which indicates that the input data bit is different from common value ν, the output Q₁ of register 506 remains “1” for the rest of bits in the page. This is because once Q₁ outputs a “1,” register 506 will retain this value until register 506 is reset. In one embodiment, the outputs of register 506 are reset to “0” at the beginning of every page, and whenever one of its outputs turns to a “1,” the system can learn that at least one incoming data bit is not equal to the common value ν.

OR gate 508 takes as inputs all eight outputs, Q₁-Q₈, of register 506. The system determines whether the received page contains only one value ν based on the output of OR gate 508 (operation 510). If the page contains only common value ν (when OR gate 508 outputs a “0”), the system maps the logical page to a virtual common-value page (operation 512). If the page does not contain a common value ν (when OR gate 508 outputs a “1”), the system maps the logical page to a physical page and proceeds with a normal page write operation (operation 514).

Note that the circuit configuration illustrated in FIG. 5 can be expanded to accommodate data buses with different widths. For instance, register 506 can accommodate 16 parallel bits to accommodate a 16-bit-wide data bus. Furthermore, multiple registers can be used in parallel to accommodate a particular data bus width. For example, two 8-bit-wide registers can be used in parallel to accommodate a 16-bit-wide data bus. Also note that the circuit can be expanded to compare various granularities of data. For example, the circuit can check for a common value ν of just one bit (“0” or all “1”), or a common value comprising multiple bits, such as a byte value ranging from 0 to 255.

It is also possible to detect the common data pattern in an incoming page in a “snapshot” fashion after all the bits have been received. For example, with reference to FIG. 2, common-data-pattern detector 208 can operate in conjunction with a data buffer within flash controller 200, or in conjunction with cache register 224 or page data register 222. This “snapshot” data comparison allows all the bits in a page to be compared with a previously stored, arbitrary data pattern, which makes the system more flexible in accommodating a variety of common data patterns.

In one embodiment, the system maintains a secondary table which maintains a record of which physical page corresponds to which common data pattern, wherein a common data pattern can contain an arbitrary pattern or only a common value. When a page of incoming data is received during a write operation, the system compares the received bits with previously stored data patterns. To reduce the computational overhead, embodiments of the present invention can use a hierarchical comparison method. For example, the system first computes a digest (such as a hash) of selected bits of the incoming page and performs a bit-to-bit comparison only when the digest of the incoming data matches the digest of a previously stored common data pattern.

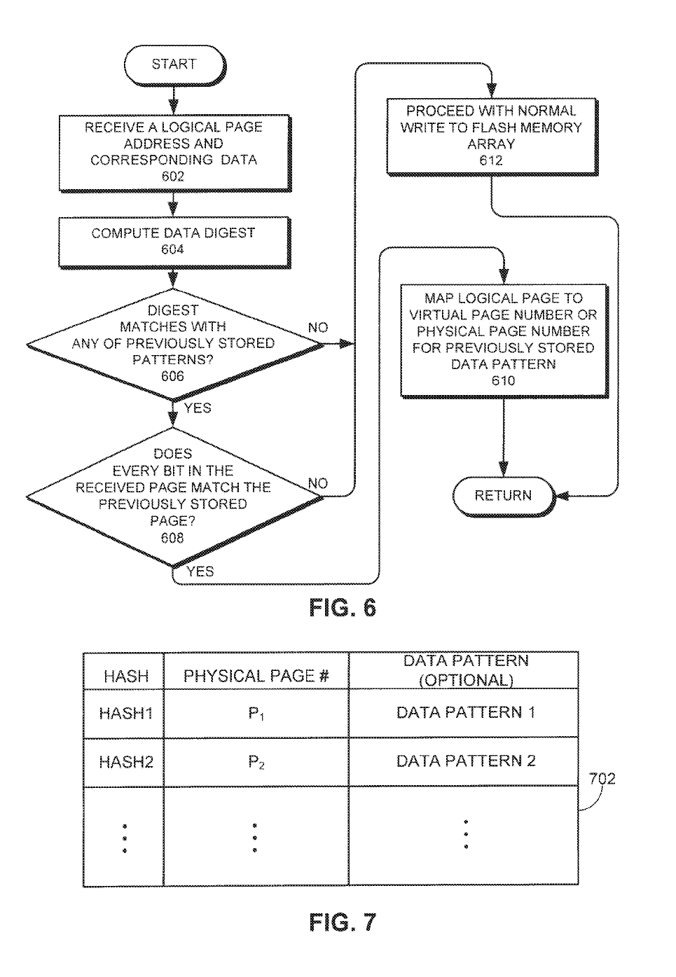

FIG. 6 presents a flowchart illustrating the operation of a hierarchical common-data-pattern detector, in accordance with an embodiment of the present invention. During operation, the system receives a logical page address and a set of corresponding data to be written into the flash memory (operation 602). The system then computes a data digest for the received page (operation 604). Note that the system can compute a hash as the digest for all the bits in the received page, or a hash just for a portion of the bits, such as every eighth bit.

Next, the system determines whether the computed digest matches any of the digests for previously stored data patterns (operation 606). If the digest does not match any previously stored digest, the system proceeds with the normal write operation to the flash memory array (operation 612). If there is a match, the system further determines whether every bit in the received page matches the bits in the previously stored page corresponding to the matching digest (operation 608). If there is a match, the system maps the logical page to a virtual page number or a physical page number for the previously stored data pattern (operation 610). If there is not a match, the system proceeds with the normal write operation to the flash memory array (operation 612).

FIG. 7 illustrates an exemplary secondary table that stores physical page numbers for common data patterns and is indexed by the digest of the data patterns, in accordance with an embodiment of the present invention. Secondary table 702 includes three columns, although the third column is optional. The first column contains the hash value of a portion or all of the bits of a previously stored data pattern, which serves as the digest for that data pattern. The second column contains the physical page number for that data pattern. The optional third column stores the complete data pattern. Alternatively, if the third column is not present, a read of the physical page indicated in the second column can be performed from the flash memory array to retrieve the full data pattern, which allows the system to perform a comparison. Table 702 can be indexed or keyed by the hash values, so that a common-data-pattern detector can search table 702 with the digest of a received page.

In some embodiments, table 702 can also be indexed or keyed by the physical page numbers, so that during a read operation the system can directly access a data pattern from table 702 by the physical page number without accessing the flash memory array. Furthermore, all or a portion (such as the digest column and physical-page column) of table 702 can be stored in the flash memory array and loaded into an SRAM in the flash controller when the device is initialized.

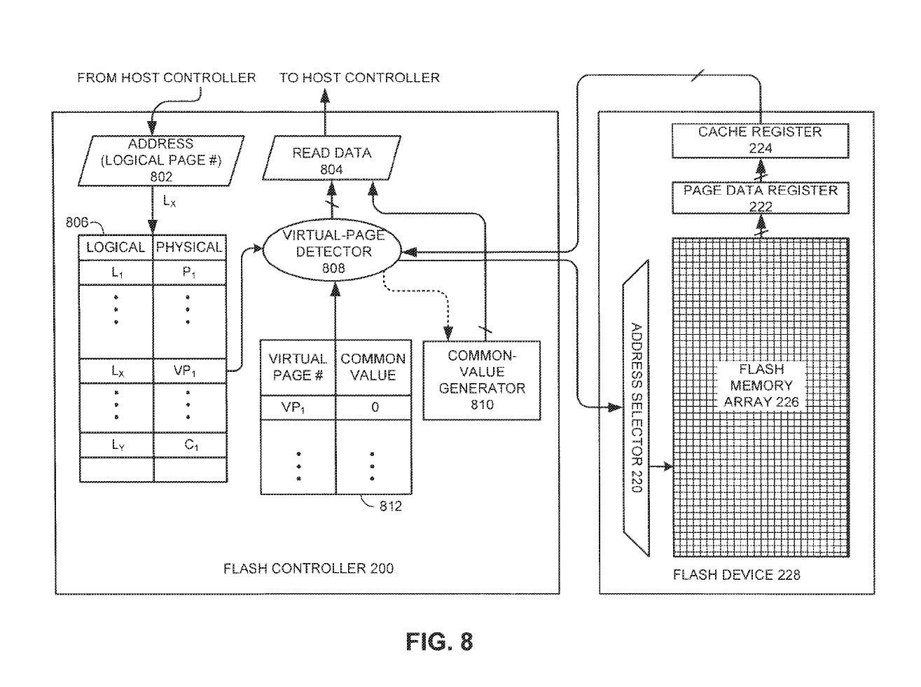

FIG. 8 illustrates an exemplary flash memory system that facilitates read operations of multiple pages of common data patterns, which are mapped to one virtual page, in accordance with an embodiment of the present invention. As illustrated in this example, during a read operation, flash controller 200 receives a logical page number 802, which is denoted as L_{X}. Flash controller 220 then searches a map table 806 for the corresponding physical page. As a result, map table 806 indicates that L_{X} corresponds to a virtual page VP₁, which is fed into a virtual-page detector 808. After determining that VP₁ is a virtual page instead of a physical page, virtual-page detector 808 retrieves the common value (which in this example is “0”) that corresponds to VP₁ from a secondary table 812. Virtual-page detector 808 then activates a common-value generator 810 to generate the common value corresponding to VP'. The generated common value which fills up an entire page is then transmitted to the host controller as the read data 804 for logical page number L_{X}.

Note that, similar to table 702, secondary table 812 can also have three columns. In this case, virtual-page detector 808 can determine whether a physical page is previously stored in table 812, and, if it is, directly load the page without accessing flash memory array 226. Furthermore, when logical page L_{X} corresponds to a physical page which has not been previously stored, virtual-page detector 808 can direct the physical page number to address selector 220 and allow flash memory array 226 to produce the read data.

Aspects of the common-data-pattern storage mechanisms described herein may be implemented as functionality programmed into any of a variety of circuitry, including programmable logic devices (PLDs), such as field-programmable gate arrays (FPGAs), programmable array logic (PAL) devices, electrically programmable logic and memory devices, and standard cell-based devices, as well as application-specific integrated circuits (ASICs). Some other possibilities for implementing aspects of the common-data-pattern storage mechanisms include: microcontrollers with memory (such as electronically erasable programmable read-only memory (EEPROM), embedded microprocessors, firmware, software, etc.).

The circuitry configuration and block diagram described in this detailed description can be implemented in integrated circuits represented by computer code, such as those in GDS or GDSII format, and stored on a computer-readable medium. This computer-readable medium may be any device or medium that can store code and/or data for use by a computer system and includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The foregoing descriptions of embodiments described herein have been presented only for purposes of illustration and description. They are not intended to be exhaustive or to limit the embodiments to the forms disclosed. Accordingly, many modifications and variations will be apparent to practitioners skilled in the art. The scope of the present invention is defined by the appended claims.

What is claimed is:

1. A method of operation within a flash memory system, the method comprising:
receiving write data and a corresponding logical address;
determining whether the write data matches a predetermined data pattern; and
if the write data does match the predetermined data pattern, instead of writing the data, recording an indication that the predetermined data pattern corresponds to the logical address.

2. The method of claim 1, further comprising:
storing the data within the flash memory system if the data does not match the predetermined data pattern.

3. The method of claim 1,
wherein recording the indication involves recording the indication in a map table.

4. The method of claim 1,
wherein the indication is a code indicating the predetermined data pattern.

5. The method of claim 1,
wherein the indication is a physical address.

6. The method of claim 5,
wherein the physical address corresponds to an unusable physical page.

7. The method of claim 1,
wherein the predetermined data pattern is a previously stored data pattern.

8. The method of claim 1,
wherein the predetermined data pattern comprises a page of predetermined value.

9. A method of operation within a flash memory system, the method comprising:
receiving a read command and a corresponding logical address;
determining whether the logical address correspond to an indication that data to be read matches a predetermined data pattern; and
if the logical address does corresponds to the indication, producing the predetermined data pattern without reading the data from a flash memory array within the flash memory system.

10. The method of claim 9, further comprising:
reading the data from the flash memory array if the logical address does not correspond to the indication.

11. The method of claim 9,
wherein the indication is a virtual page address associated with the predetermined data pattern.

12. The method of claim 11,
wherein producing the predetermined data pattern involves generating the values of the data pattern.

13. The method of claim 9,
wherein the indication is a physical address.

14. The method of claim 13,
wherein the physical address corresponds to an unusable physical page.

15. The method of claim 9,
wherein the predetermined data pattern is a previously detected data pattern.

16. The method of claim 9,
wherein the predetermined data pattern comprises a page of predetermined value.

17. A flash memory system, comprising:
receiver circuitry to receive write data and a corresponding logical address;
determination circuitry coupled to the receiver circuitry to determine whether the write data matches a predetermined data pattern; and
indication-recording circuitry coupled to the determination circuitry to record an indication that the predetermined data pattern corresponds to a logical address if the write data matches the predetermined data pattern, instead of writing the data.

18. The flash memory system of claim 17, further comprising:
a flash memory array to store the data within the flash memory system if the data does not match the predetermined data pattern.

19. The flash memory system of claim 17,
further comprising a map table where the indication can be recorded.

20. The flash memory system of claim 17,
wherein the indication is a code indicating the predetermined data pattern.

21. The flash memory system of claim 17,
wherein the indication is a physical address.

22. The flash memory system of claim 21,
wherein the physical address corresponds to an unusable physical page.

23. The flash memory system of claim 17,
wherein the predetermined data pattern is a previously stored data pattern.

24. The flash memory system of claim 17,
wherein the predetermined data pattern comprises a page of predetermined value.

25. A flash memory system, comprising:
receiver circuitry to receive a read command and a corresponding logical address;
determination circuitry coupled to the receiver circuitry to determine whether the logical address corresponds to an indication that data to be read matches a predetermined data pattern; and
data-producing circuitry to produce the predetermined data pattern without reading the data from a flash memory array within the flash memory system, if the logical address does correspond to the indication.

26. The flash memory system of claim 25, further comprising:
data-reading circuitry to read the data from the flash memory array if the logical address does not correspond to the indication.

27. The flash memory system of claim 25,
wherein the indication is a virtual page address associated with the predetermined data pattern.

28. The flash memory system of claim 27,
wherein producing the predetermined data pattern involves generating the values of the data pattern.

29. The flash memory system of claim 25,
wherein the indication is a physical address.

30. The flash memory system of claim 29,
wherein the physical address corresponds to an unusable physical page.

31. The flash memory system of claim 25,
wherein the predetermined data pattern is a previously stored data pattern.

32. The flash memory system of claim 25,
wherein the predetermined data pattern comprises a page of predetermined value.

33. A computer-readable medium containing data representing a circuit that includes:
receiver circuitry to receive write data and a corresponding logical address;
determination circuitry coupled to the receiver circuitry to determine whether the write data matches a predetermined data pattern; and
indication-recording circuitry coupled to the determination circuitry to record an indication that the predetermined data pattern corresponds to a logical address if the write data matches the predetermined data pattern, instead of writing the data.

34. A computer-readable medium containing data representing a circuit that includes:
receiver circuitry to receive a read command for data to be read and a corresponding logical address;
determination circuitry coupled to the receiver circuitry to determine whether the logical address corresponds to an indication that the data to be read matches a predetermined data pattern; and
data-producing circuitry to produce the predetermined data pattern without reading the data from a flash memory array within the flash memory system, if the logical address does correspond to the indication.

35. Circuitry within a flash memory system, the circuitry comprising:
means for receiving write data and a corresponding logical address;
means for determining whether the write data matches a predetermined data pattern; and
means for recording an indication that the predetermined data pattern corresponds to the logical address instead of writing the data if the write data does match the predetermined data pattern.

36. Circuitry within a flash memory system, the circuitry comprising:
means for receiving a read command for data to be read and a corresponding logical address;
means for determining whether the logical address corresponds to an indication that the data to be read matches a predetermined data pattern; and
means for producing the predetermined data pattern without reading the data from a flash memory array within the flash memory system if the logical address does correspond to the indication.
